(19) United States
(12) Patent Application Publication
(10) Pub. No.: US 2026/0126634 A1
(43) Pub. Date: May 7, 2026

(54) OPTICAL ELEMENT AND METHOD OF MANUFACTURING OPTICAL ELEMENT

(71) Applicant: CANON KABUSHIKI KAISHA, Tokyo (JP)

(72) Inventors: JUNZO KOBAYASHI, Tochigi (JP); KENTARO MORI, Tochigi (JP); KANAKO SHIMBA, Tochigi (JP)

(21) Appl. No.: 19/372,572

(22) Filed: Oct. 29, 2025

(30) Foreign Application Priority Data
Nov. 7, 2024 (JP) 2024-195334
Sep. 5, 2025 (JP) 2025-147823

(51) Int. Cl. G02B 19/00; G02B 1/00

(52) U.S. Cl. CPC G02B 19/0004; G02B 1/002

(57) ABSTRACT

Provided is an optical element including: a substrate; and a metasurface formed on the substrate, the metasurface including a first metaatom through which light is capable of propagating, and a second metaatom through which light is capable of propagating, wherein the second metaatom differs from the first metaatom in refractive index, the first metaatom having the same material composition as a material composition of the substrate.

### BACKGROUND

### Field of the Technology

The present disclosure relates to an optical element and a method of manufacturing an optical element.

### Description of the Related Art

Various apparatuses such as mirrorless cameras, smartphones, microscopes, and semiconductor exposure apparatus have optical systems for condensing desired light. Those optical systems use various lenses. The optical systems using those lenses have an optical design that uses a plurality of lenses to accomplish highly precise light condensation in which various aberrations are corrected.

In recent years, mirrorless cameras, smartphones, and other such apparatuses have been demanded to be even smaller in size. However, in existing optical systems which use lenses to condense light through refraction of light by a curved surface shape and a refractive index of a medium, there is a limit to reduction of an optical system size and, accordingly, highly precise light condensation in which various aberrations are corrected and downsizing of the optical system have a trade-off relationship.

Japanese Patent Laid-Open No. 2021-71727 addresses this issue and states that, by adopting an optical system configuration that combines a refractive lens with an optical element having a metasurface, thickness reduction of the optical system and solving of aberration problems are achieved.

However, optical elements of the related art that have a metasurface have a low degree of freedom in designing of a metasurface. There is a wide range of needs for optical elements having a metasurface, and improvement of the degree of freedom in designing of a metasurface is accordingly demanded.

### SUMMARY

Thus, the present disclosure is directed to an optical element and a method of manufacturing an optical element with which the degree of freedom in designing of a metasurface can be improved.

According to one aspect of the present disclosure, there is provided an optical element including: a substrate; and a metasurface formed on the substrate, wherein the metasurface includes a first metaatom through which light is capable of propagating, and a second metaatom through which light is capable of propagating, wherein the second metaatom differs from the first metaatom in refractive index, and wherein the first metaatom has the same material composition as a material composition of the substrate.

According to another aspect of the present disclosure, there is provided a method of manufacturing an optical element, including: forming a first metaatom on a surface of a substrate by processing the surface; and forming a second metaatom different from the first metaatom in refractive index, on the substrate with the first metaatom formed thereon.

According to still another aspect of the present disclosure, there is provided an optical element including a metasurface, the metasurface including a solid medium through which light is capable of propagating, the solid medium including, at least, a first metaatom, a second metaatom, and a third metaatom, the first metaatom, the second metaatom, and the third metaatom differing from one another in refractive index, the first metaatom containing one of a silicon oxide or a metal oxide, or being a plastic resin.

According to yet another aspect of the present disclosure, there is provided a method of manufacturing an optical element, including: forming a first metaatom on a surface of a substrate by processing the surface; forming a second metaatom different from the first metaatom in refractive index, on the surface with the first metaatom formed thereon; and forming a third metaatom different from the first metaatom and the second metaatom in refractive index, on the surface with the first metaatom and the second metaatom formed thereon.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view for illustrating an optical element according to a first embodiment of the present disclosure.

FIG. 1B is a sectional view for illustrating the optical element according to the first embodiment of the present disclosure.

FIG. 2 is a flow chart for illustrating steps of a method of manufacturing the optical element according to the first embodiment of the present disclosure.

FIG. 3A is a sectional view for illustrating a step of the method of manufacturing the optical element according to the first embodiment of the present disclosure.

FIG. 3B is a sectional view for illustrating a step of the method of manufacturing the optical element according to the first embodiment of the present disclosure.

FIG. 3C is a sectional view for illustrating a step of the method of manufacturing the optical element according to the first embodiment of the present disclosure.

FIG. 3D is a sectional view for illustrating a step of the method of manufacturing the optical element according to the first embodiment of the present disclosure.

FIG. 3E is a sectional view for illustrating a step of the method of manufacturing the optical element according to the first embodiment of the present disclosure.

FIG. 3F is a sectional view for illustrating a step of the method of manufacturing the optical element according to the first embodiment of the present disclosure.

FIG. 3G is a sectional view for illustrating a step of the method of manufacturing the optical element according to the first embodiment of the present disclosure.

FIG. 3H is a sectional view for illustrating a step of the method of manufacturing the optical element according to the first embodiment of the present disclosure.

FIG. 3I is a sectional view for illustrating a step of the method of manufacturing the optical element according to the first embodiment of the present disclosure.

FIG. 4A is a perspective view for illustrating an optical element according to a second embodiment of the present disclosure.

FIG. 4B is a sectional view for illustrating the optical element according to the second embodiment of the present disclosure.

FIG. 5A is a sectional view for illustrating a step of a method of manufacturing the optical element according to the second embodiment of the present disclosure.

FIG. 5B is a sectional view for illustrating a step of the method of manufacturing the optical element according to the second embodiment of the present disclosure.

FIG. 5C is a sectional view for illustrating a step of the method of manufacturing the optical element according to the second embodiment of the present disclosure.

FIG. 5D is a sectional view for illustrating a step of the method of manufacturing the optical element according to the second embodiment of the present disclosure.

FIG. 5E is a sectional view for illustrating a step of the method of manufacturing the optical element according to the second embodiment of the present disclosure.

FIG. 5F is a sectional view for illustrating a step of the method of manufacturing the optical element according to the second embodiment of the present disclosure.

FIG. 5G is a sectional view for illustrating a step of the method of manufacturing the optical element according to the second embodiment of the present disclosure.

FIG. 5H is a sectional view for illustrating a step of the method of manufacturing the optical element according to the second embodiment of the present disclosure.

FIG. 5I is a sectional view for illustrating a step of the method of manufacturing the optical element according to the second embodiment of the present disclosure.

FIG. 5J is a sectional view for illustrating a step of the method of manufacturing the optical element according to the second embodiment of the present disclosure.

FIG. 5K is a sectional view for illustrating a step of the method of manufacturing the optical element according to the second embodiment of the present disclosure.

FIG. 5L is a sectional view for illustrating a step of the method of manufacturing the optical element according to the second embodiment of the present disclosure.

FIG. 6 is a sectional view for illustrating an optical element according to a third embodiment of the present disclosure.

FIG. 7 is a sectional view for illustrating another example of a configuration related to metaatoms in the optical element according to the third embodiment of the present disclosure.

FIG. 8 is a sectional view for illustrating an example in which a peripheral region is filled with a solid in the optical element according to the third embodiment of the present disclosure.

FIG. 9 is a flow chart for illustrating steps of a method of manufacturing the optical element according to the third embodiment of the present disclosure.

FIG. 10A is a sectional view for illustrating a step of the method of manufacturing the optical element according to the third embodiment of the present disclosure.

FIG. 10B is a sectional view for illustrating a step of the method of manufacturing the optical element according to the third embodiment of the present disclosure.

FIG. 10C is a sectional view for illustrating a step of the method of manufacturing the optical element according to the third embodiment of the present disclosure.

FIG. 10D is a sectional view for illustrating a step of the method of manufacturing the optical element according to the third embodiment of the present disclosure.

FIG. 10E is a sectional view for illustrating a step of the method of manufacturing the optical element according to the third embodiment of the present disclosure.

FIG. 11 is a sectional view for illustrating an optical element according to a fourth embodiment of the present disclosure.

### DESCRIPTION OF THE EMBODIMENTS

### First Embodiment

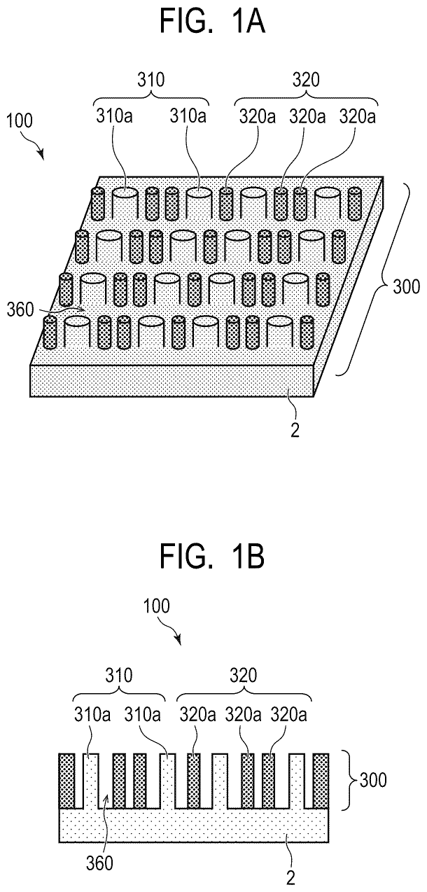

An optical element and a method of manufacturing an optical element according to a first embodiment of the present disclosure are described with reference to FIG. 1A to FIG. 3I.

First, a configuration of the optical element according to the present embodiment is described with reference to FIG. 1A and FIG. 1B. FIG. 1A is a perspective view for illustrating an optical element 100 according to the present embodiment. FIG. 1B is a sectional view for illustrating the optical element 100 according to the present embodiment.

As illustrated in FIG. 1A and FIG. 1B, the optical element 100 according to the present embodiment includes a substrate 2 and a metasurface 300 formed on a surface of the substrate 2. The metasurface 300 is configured from a plurality of metaatom groups and, specifically, has at least a first metaatom group 310 and a second metaatom group 320, which differs from the first metaatom group 310. A metaatom group is a group of metaatoms. A metaatom is an artificially provided structural object, and has a size sufficiently small with respect to a wavelength of target light that is a target of the optical element 100. The first metaatom group 310 is a group of first metaatoms 310a. The second metaatom group 320 is a group of second metaatoms 320a. The substrate 2 is portions immediately below the plurality of first metaatoms 310a and immediately below the plurality of second metaatoms 320a, and portions that connect the underlying portions to one another.

The metasurface 300 includes a void portion 360. That is, spaces between one of the first metaatoms 310a and another of the first metaatoms 310a, between one of the first metaatoms 310a and one of the second metaatoms 320a, and between one of the second metaatoms 320a and another of the second metaatoms 320a are each the void portion 360. The void portion 360 thus included in the metasurface 300 is filled with, for example, air.

The plurality of metaatom groups in the optical element 100 are distinguished from one another by material compositions that configure the respective metaatoms. That is, the first metaatoms 310a which form the first metaatom group 310 and the second metaatoms 320a which form the second metaatom group 320 are configured by material compositions having refractive indices different from each other with respect to the target light of the optical element 100. The first metaatom group 310 and the second metaatom group 320 are thus configured by material compositions having refractive indices different from each other with respect to the target light of the optical element 100. For example, the refractive index of the first metaatom group 310 is lower than the refractive index of the second metaatom group 320.

In addition, the material composition of the first metaatom group 310 is the same as a material composition of the substrate 2. Here, having the same material composition means that material compositions of most portions or main portions that dictate optical characteristics of two objects of interest are the same as each other. Differences due to superficial or internal transmutation or the like that is caused in the objects by processing, treatment, or the like do not keep the objects from having the same material composition.

Action of a metasurface on light varies for different wavelengths, different incident angles, and different manners of polarization. Accordingly, optimization for a specific incidence condition is possible, whereas it is difficult to accommodate a wide range of incidence conditions. This is why the only optical elements having a metasurface that are currently in the market are products with limited incidence conditions such as a Time-of-Flight (TOF) sensor using a monochromatic laser.

One of reasons for the difficulty of accommodating a wide range of incidence conditions is a low degree of freedom in designing of a metasurface due to smallness of the number of methods of forming a metasurface and the number of materials that are selectable as a material of a metasurface. There is a wide range of needs, including an achromatic lens which accommodates a wide spectrum range and a large field-of-view (FOV) lens which accommodates a wide range of incident angles, for optical elements having a metasurface, and improvement of the degree of freedom in designing of a metasurface is accordingly demanded.

With this regard, in the present embodiment, the material composition of the first metaatom group 310 which is at least one metaatom group out of the plurality of metaatom groups in the optical element 100 is the same as the material composition of the substrate 2. There are many materials to choose from for the substrate 2, and, having the same material composition as that of such substrate 2, the first metaatom group 310 also has many materials that are selectable as its material. Thus, according to the present embodiment, the degree of freedom in designing of the metasurface 300 can be improved.

In addition, the first metaatom group 310 which has the same material composition as that of the substrate 2 is more preferred to be formed continuously from the substrate 2. In this case, the first metaatom group 310 is formable by processing the substrate 2, and the material composition of the first metaatom group 310 can accordingly be selected without taking what film forming method is to be used into account. As a result, a wider range of options for the material composition of the first metaatom group 310 becomes available, and the degree of freedom in designing of the metasurface 300 can accordingly be improved. Note that being continuously formed here means that the first metaatom group 310 and the substrate 2 are a unitary structural object without a boundary, and that the first metaatom group 310 is configured from a part of a surface shape of the substrate 2.

The metasurface 300 is preferred to include three or more types of media through which the target light of the optical element 100 can be transmitted and propagated. In the present embodiment, the metasurface 300 includes three types of media which are the first metaatom group 310 as a first medium, the second metaatom group 320 as a second medium, and the air or another medium in the void portion 360 as a third medium. The metasurface 300 is configured so that propagation of the target light is possible through the medium of the meta surface 300. The metasurface 300 is configured so that the targe light is capable of propagating through the metaatom. The first medium, the second medium, and the third medium are media through which the target light of the optical element 100 can be transmitted and propagated, and have refractive indices different from one another with respect to the target light of the optical element 100. With the metasurface 300 including three or more types of media, the number of combinations of media that configure the metasurface 300 is increased, and the degree of freedom in designing of the metasurface 300 can accordingly be improved.

A specific description is given below on the substrate 2, the metasurface 300, the first metaatoms 310a, and the second metaatoms 320a of the optical element 100 according to the present embodiment.

The substrate 2 is transmissive with respect to light of a desired wavelength that is a target wavelength of the optical element 100, and serves as a foundation for configuring the metasurface 300 on a surface. Specifically, the substrate 2 is a substrate such as a glass substrate, a resin substrate, or a silicon substrate. A size and a thickness suitable for a use of the optical element 100 may be selected for the substrate 2.

Various materials are selectable for the substrate 2 depending on the use of the optical element 100. For example, in a case in which the target light of the optical element 100 is visible light having a wavelength of 400 nm or more and 800 nm or less, a material containing a metal oxide is preferred to be selected as the material of the substrate 2. Specifically, it is preferred in this case to select, as the material of the substrate 2, a material containing at least one type of oxide out of oxides of La, Nb, W, Ti, K, Na, and Li. Alternatively, it is preferred in this case to select, as the material of the substrate 2, a material that is a resin containing cycloolefin, or a resin containing polyolefin. When performance as the optical element 100 is taken into account, the substrate 2 is preferred to have, at least, a transmittance of 60% or more with respect to visible light having a wavelength of 400 nm or more and 800 nm or less that is the target light of the optical element 100.

In contrast, in a case in which the target light of the optical element 100 has a wavelength longer than that of visible light, it is preferred to select, as the material of the substrate 2, a material containing at least one type out of polycrystalline silicon, Ge, ZnSe, SeS, ZnS, CaF₂, sapphire, and chalcogenide glass.

In a case in which the target light of the optical element 100 has a wavelength shorter than that of visible light, it is preferred to select, as the material of the substrate 2, a material containing at least one type of fluoride out of fluorides of Al, Mg, Ca, Ba, and Sr. Note that the case in which the target light has a wavelength shorter than that of visible light is, specifically, a case in which ultraviolet light having a wavelength of 257 nm or more and 360 nm or less is the target.

Others selectable as the material of the substrate 2 include an oxide, a nitride, or an oxynitride of one type of element out of Si, Al, Ti, Hf, Ta, and Nb, depending on the use.

The metasurface 300 is an optical surface provided on the surface of the substrate 2 and, in the present embodiment, includes the first metaatom group 310 and the second metaatom group 320. The first metaatom group 310 and the second metaatom group 320 are configured by material compositions having refractive indices different from each other with respect to the target light of the optical element 100.

The first metaatom group 310 is a group of a plurality of first metaatoms 310a. The second metaatom group 320 is a group of a plurality of second metaatoms 320a. The first metaatom group 310 and the second metaatom group 320 are distinguished from each other by the material composition that configures the first metaatoms 310a and the material composition that configures the second metaatoms 320a.

The metasurface 300 is preferred to include three or more types of media through which the target light of the optical element 100 can be transmitted and propagated. In the case of the present embodiment, the metasurface 300 includes three types of media which are the first metaatom group 310 as the first medium, the second metaatom group 320 as the second medium, and the air or another medium in the void portion 360 as the third medium.

The first metaatom group 310 has the same material composition as that of the substrate 2 and, as is the case for the substrate 2, a material suitable for the wavelength of the target light of the optical element 100 is selectable for the first metaatom group 310. That is, in the case in which the target light of the optical element 100 is visible light having a wavelength of 400 nm or more and 800 nm or less, a material containing a metal oxide is preferred to be selected as the material of the first metaatom group 310. Specifically, it is preferred in this case to select, as the material of the first metaatom group 310, a material containing at least one type of oxide out of oxides of La, Nb, W, Ti, K, Na, and Li. Alternatively, a material containing one of a resin that contains cycloolefin and a resin that contains polyolefin is selectable in this case as the material of the first metaatom group 310.

In contrast, in the case in which the target light of the optical element 100 has a wavelength longer than that of visible light, it is preferred to select, as the material of the first metaatom group 310, a material containing at least one type out of polycrystalline silicon, Ge, ZnSe, SeS, ZnS, CaF₂, sapphire, and chalcogenide glass.

In the case in which the target light of the optical element 100 has a wavelength shorter than that of visible light, the material of the first metaatom group 310 may be selected from materials containing at least one type of fluoride out of fluorides of Al, Mg, Ca, Ba, and Sr.

Others selectable as the material of the first metaatom group 310 include an oxide, a nitride, or an oxynitride of one type of element out of Si, Al, Ti, Hf, Ta, and Nb.

As a material of the second metaatom group 320, an oxide, a nitride, or an oxynitride of at least one type of element out of Si, Al, Ti, Hf, Ta, and Nb is selectable. Alternatively, a material containing at least one type of fluoride out of fluorides of Al, Mg, Ca, Ba, and Sr may be selected as the material of the second metaatom group 320.

In contrast to the first metaatom group 310 and the second metaatom group 320, media selectable as the third medium through which third type of light can be transmitted and propagated include air, water, plastic resins such as thermoplastic resins, Si oxides, MgF₂, porous substances, and the like. The third medium can fill the void portion 360. The third medium differs from the first metaatom group 310 and the second metaatom group 320 in refractive index, and is preferred to be a low-refractive index medium lower in refractive index with respect to the target light than the material compositions that configure the first metaatoms 310a and the second metaatoms 320a.

The metasurface 300 can be designed so as to exert a refraction effect via propagation phase delay, geometrical phase delay, or the like on light in a desired wavelength range that is the target light of the optical element 100, by a combination of the first metaatom group 310, the second metaatom group 320, and the third medium.

The first metaatoms 310a are artificial structural objects each having a pillar structure, and form the first metaatom group 310. Values suitable for the wavelength of the target light that is the target of the optical element 100 are selectable for a sectional shape and a height of the first metaatoms 310a and a distance between two of the first metaatoms 310a. In principle, the first metaatoms 310a each have a size sufficiently small with respect to the wavelength of the target light that is the target of the optical element 100.

The first metaatoms 310a which form the first metaatom group 310 are preferred to have the same material composition as that of the substrate 2. It is more preferred for the first metaatoms 310a to be a structural object unitary with the substrate 2, without a boundary to the substrate 2, and be a part of the surface shape of the substrate 2. That is, the first metaatoms 310a are more preferred to be a structural object formed by processing the surface of the substrate 2.

The second metaatoms 320a are artificial structural objects each having a pillar structure, and form the second metaatom group 320. Values suitable for the wavelength of the target light that is the target of the optical element 100 are selectable for a sectional shape and a height of the second metaatoms 320a and a distance between two of the second metaatoms 320a. In principle, the second metaatoms 320a each have a size sufficiently small with respect to the wavelength of the target light that is the target of the optical element 100.

The second metaatoms 320a which form the second metaatom group 320 are structural objects formed on the substrate 2 by a material composition different in refractive index from the first metaatoms 310a which form the first metaatom group 310, that is, a material composition different in refractive index from the substrate 2. As a material of the second metaatoms 320a, materials that can be formed into a film by dry deposition such as chemical vapor deposition (CVD) or atomic layer deposition (ALD), or by wet coating such as dipping, spin coating, or the like, are usable.

The first metaatoms 310a and the second metaatoms 320a are each not limited to structural objects having a pillar structure, and may be structural objects having other convex structures.

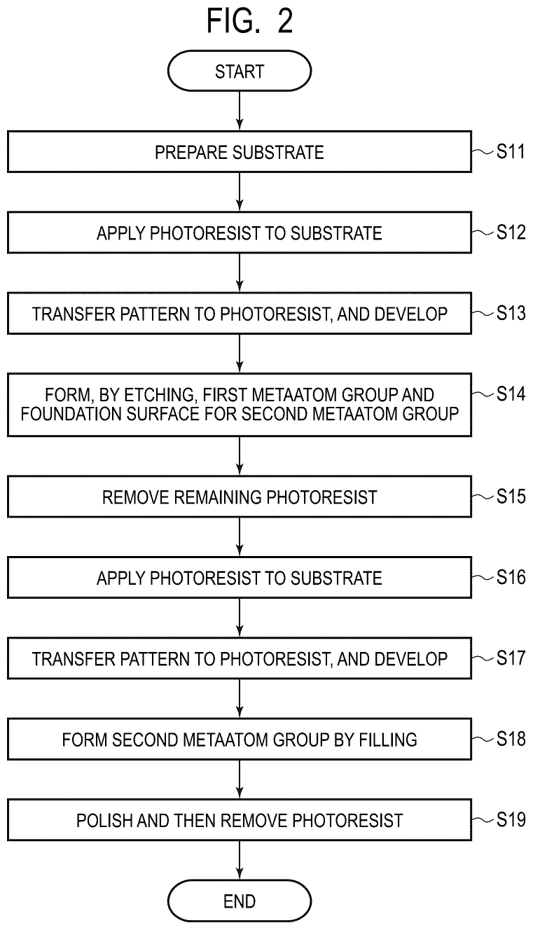

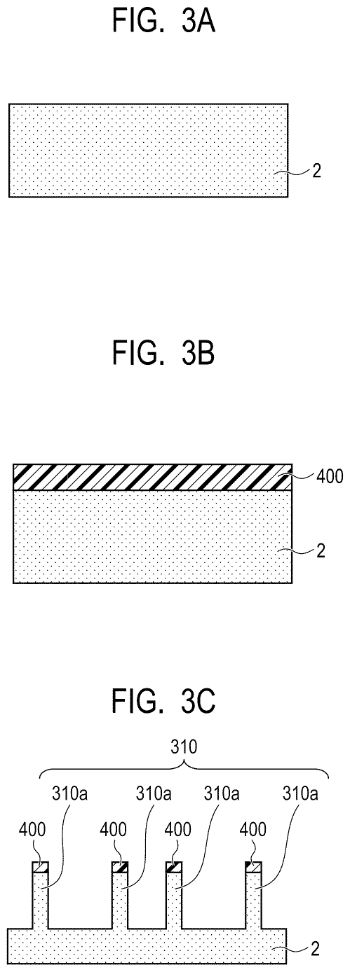

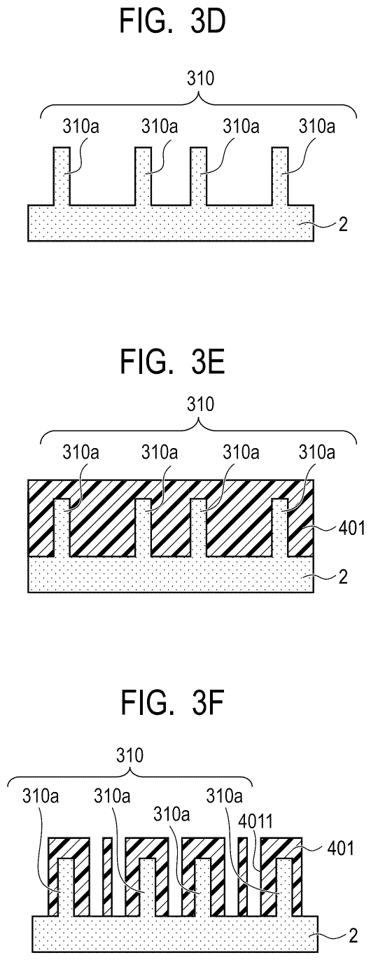

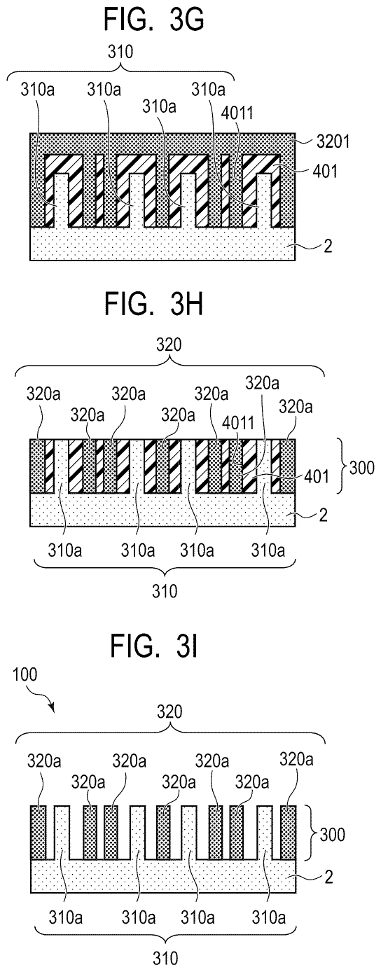

A method of manufacturing the optical element 100 according to the present embodiment is described next with reference to FIG. 2 to FIG. 3I. FIG. 2 is a flow chart for illustrating manufacturing steps in the method of manufacturing the optical element 100 according to the present embodiment. FIG. 3A to FIG. 3I are sectional views for illustrating steps of an example of the method of manufacturing the optical element 100 according to the present embodiment.

First, as illustrated in FIG. 3A, the substrate 2 to be used for forming of the optical element 100 is prepared (Step S11). A material having a predetermined shape such as a board shape, a sheet shape, or the like may be prepared as the substrate 2.

Next, the first metaatom group 310 is shaped on a surface of the substrate 2 and a foundation surface for shaping the second metaatom group 320 is concurrently formed on the surface of the substrate 2 by processing the surface of the substrate 2. In this processing step, removal by etching is preferred to be used to process the substrate 2. The processing step of processing the substrate 2 with the use of removal by etching is specifically as follows.

First, as illustrated in FIG. 3B, a positive photoresist 400 is applied to a surface of the prepared substrate 2 (Step S12).

Next, the photoresist 400 is exposed to light, with an exposure apparatus, above a surrounding portion of a portion of the substrate 2 that becomes the first metaatoms 310a which form the first metaatom group 310, and above a portion of the substrate 2 that becomes the foundation surface for the second metaatom group 320. This increases solubility of the photoresist 400 above those portions. Next, portions of the photoresist 400 that have been increased in solubility by exposure to light are removed with a solvent, and development is executed. In this manner, a pattern is transferred onto the photoresist 400 and development is executed by photolithography (Step S13). The photoresist 400 onto which the pattern has been transferred has a covering pattern corresponding to the first metaatoms 310a which form the first metaatom group 310. Note that the step of forming a pattern in the photoresist 400 is not limited to a step by photolithography, and may be a step of forming a pattern in the photoresist 400 by other methods such as imprinting or the like. The photoresist 400 with a pattern formed therein is thus formed by photolithography, imprinting, or the like as a mask to be used in the next step, which is etching.

The photoresist 400 with a pattern formed therein is then used as a mask to engrave the substrate 2 with use of a processing method such as ion beam etching, reactive ion etching, or the like. Thus, as illustrated in FIG. 3C, the first metaatom group 310 is shaped on the surface of the substrate 2 and the foundation surface for shaping the second metaatom group 320 in a later step is concurrently formed on the surface of the substrate 2 (Step S14). The remaining photoresist 400 is then removed as illustrated in FIG. 3D (Step S15).

Next, as illustrated in FIG. 3E, a positive photoresist is applied again as a photoresist 401 so as to cover the processed surface of the substrate 2 (Step S16).

The photoresist 401 is next exposed to light, with the exposure apparatus, above a portion for forming the second metaatoms 320a which is included in the foundation surface for shaping the second metaatom group 320 in the substrate 2. This increases solubility of the photoresist 401 above this portion. Next, a portion of the photoresist 401 that has been increased in solubility by exposure to light is removed with a solvent, and development is executed. In this manner, as illustrated in FIG. 3F, a pattern is transferred onto the photoresist 401 and development is executed by photolithography (Step S17). The photoresist 401 onto which the pattern has been transferred has an opening pattern that includes opening portions 4011 corresponding to the second metaatoms 320a which form the second metaatom group 320. Note that the step of forming a pattern in the photoresist 401 is not limited to a step by photolithography, and may be a step of forming a pattern in the photoresist 401 by other methods such as imprinting or the like. The photoresist 401 with a pattern formed therein is thus formed by photolithography, imprinting, or the like as a mask to be used in the next step, which is film forming.

Next, as illustrated in FIG. 3G, a film 3201 is formed from a material for forming the second metaatoms 320a of the second metaatom group 320 to fill the opening portions 4011 developed in the photoresist 401 with a pattern formed therein (Step S18). Methods such as CVD, ALD, dipping, spin coating, and the like are usable to form the film 3201.

Next, as illustrated in FIG. 3H, the film 3201 and the photoresist 401 are polished by chemical mechanical polishing (CMP) or other methods until the first metaatoms 310a are reached, to thereby level the metasurface 300. The second metaatoms 320a made from the film 3201 which fills the opening portions 4011 are thus formed on the substrate 320.

Next, as illustrated in FIG. 3I, the photoresist 401 remaining on the substrate 2 is removed with a solvent (Step S19). Functional films such as a protective film and an anti-reflection film may then be provided as appropriate on the metasurface 300. The substrate 2 may be cleaved to an element size of the optical element 100. The optical element 100 according to the present embodiment can be manufactured in this manner.

Thus, according to the present embodiment, the number of selectable materials for forming the first metaatom group 310 can be increased because the first metaatom group 310 is formed by the same material composition as the material composition of the substrate 2 with the use of the substrate 2. The present embodiment can accordingly improve the degree of freedom in designing of the metasurface 300. With the degree of freedom in designing of the metasurface 300 improved, application of the optical element 100 including the metasurface 300 can be expanded to a broad range of uses and products.

Note that, although the description of the present embodiment takes, as an example, a case in which the metasurface 300 includes two types of metaatom groups: the first metaatom group 310 and the second metaatom group 320 as the plurality of metaatom groups, the present embodiment is not limited thereto. The metasurface 300 may include three or more types of metaatom groups. In this case, another metaatom group different in refractive index from the first metaatom group 310 and the second metaatom group 320 is further formable on the substrate 2 in the same manner as the manner of forming the second metaatom group 320.

### Second Embodiment

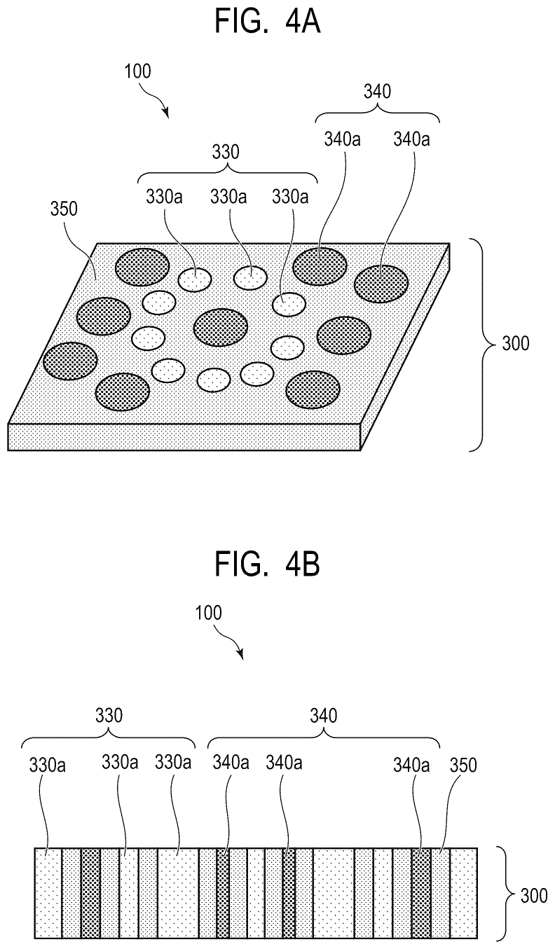

An optical element according to a second embodiment of the present disclosure is described with reference to FIG. 4A and FIG. 4B. Note that components similar to those of the optical element according to the first embodiment described above are denoted by the same reference symbols, and descriptions thereof are omitted or simplified.

First, a configuration of the optical element according to the present embodiment is described with reference to FIG. 4A and FIG. 4B. FIG. 4A is a perspective view for illustrating the optical element 100 according to the present embodiment. FIG. 4B is a sectional view for illustrating the optical element 100 according to the present embodiment.

As illustrated in FIG. 4A and FIG. 4B, the optical element 100 according to the present embodiment is configured with the metasurface 300. The metasurface 300 is configured from a plurality of metaatom groups and, specifically, includes at least a first metaatom group 330, a second metaatom group 340, and a metaatom 350. The first metaatom group 330 and the second metaatom group 340 differ from each other. The first metaatom group 330 is a group of first metaatoms 330a. The second metaatom group 340 is a group of second metaatoms 340a. The metaatom 350 is a structural object filling spaces between one of the first metaatoms 330a and another of the first metaatoms 330a, between one of the second metaatoms 340a and another of the second metaatoms 340a, and between one of the first metaatoms 330a and one of the second metaatoms 340a.

The first metaatoms 330a which form the first metaatom group 330, the second metaatoms 340a which form the second metaatom group 340, and the metaatom 350 have material compositions different from one another in refractive index. Materials of the first metaatoms 330a, the second metaatoms 340a, and the metaatom 350 are each a medium through which the target light of the optical element 100 can be transmitted and propagated, and are each a solid. In the case of the present embodiment, the metasurface 300 includes three types of solid media which are the first metaatom group 330 as a first medium, the second metaatom group 340 as a second medium, and the metaatom 350 as a third medium.

In the optical element 100 according to the present embodiment, as illustrated in FIG. 4A and FIG. 4B, the metasurface 300 is not provided on a substrate. In this case, the optical element 100 can be configured by close adhesion among the first metaatoms 330a, the second metaatoms 340a, and the metaatom 350.

In the present embodiment, the metasurface 300 is thus not provided on a substrate. Accordingly, in the present embodiment, the material composition of the first metaatom group 330 is preferred to be glass containing an oxide that is a silicon oxide or a metal oxide, or to be a plastic resin, from the viewpoint of rigidity and ease of manufacture of the optical element 100. In particular, the oxide contained in glass is preferred to be at least one type of oxide out of oxides of Si, La, Nb, W, Ti, K, Na, and Li. A preferred plastic resin is a resin containing cycloolefin, or a resin containing polyolefin.

Note that the first metaatom group 330 can be formed by processing a temporary substrate 3 as described later. The same material as that of the substrate 2 in the first embodiment is usable as a material of the temporary substrate 3 and, accordingly, the first metaatom group 330 can also be of the same material as that of the substrate 2 in the first embodiment.

Material compositions of the second metaatom group 340 and the metaatom 350 are preferred to be the same as those of the second metaatom group 320 in the first embodiment and different from each other in refractive index.

In the present embodiment, with the metasurface 300 not being provided on a substrate, thickness reduction of the optical element 100 and improvement of the degree of freedom in designing of the metasurface 300 are accomplished at the same time.

Note that the metasurface 300 in the present embodiment may also be provided on the substrate 2 as in the first embodiment. In this case, the first metaatom group 330 is preferred to have the same material composition as that of the substrate 2, and is more preferred to be formed continuously from the substrate 2.

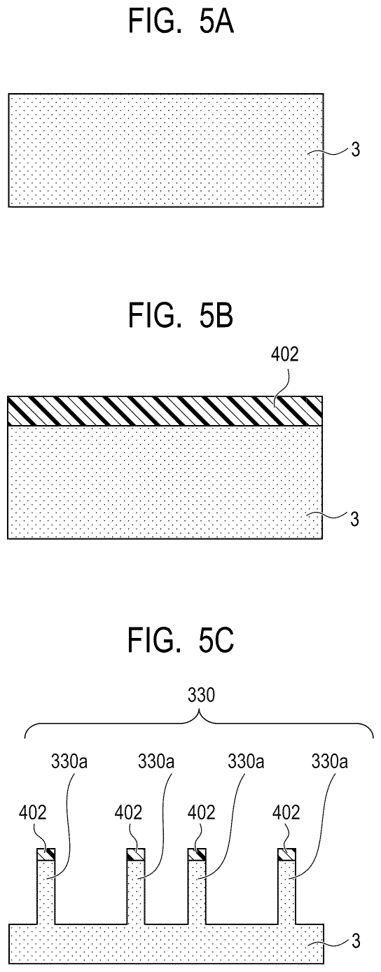

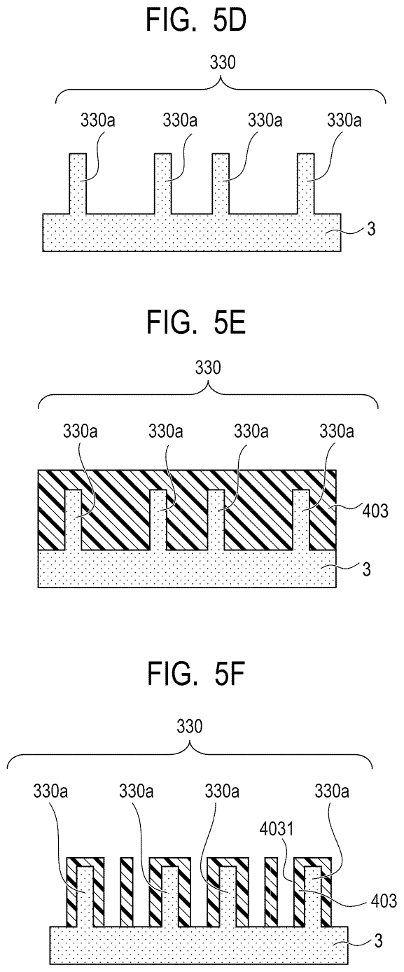

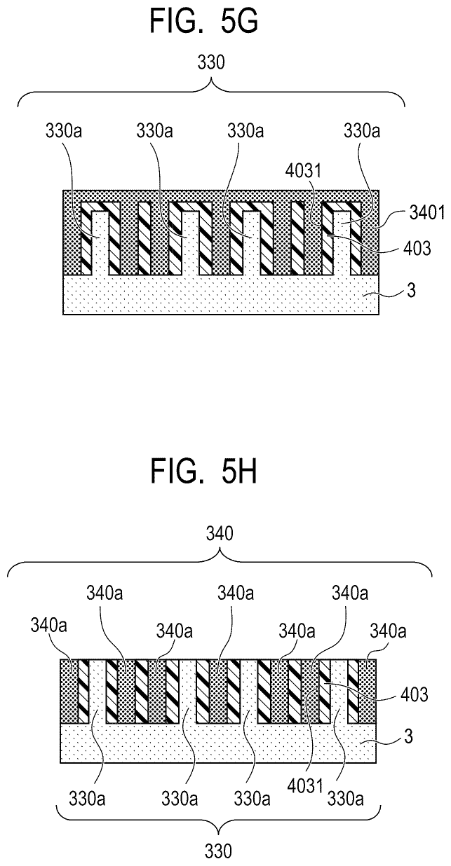

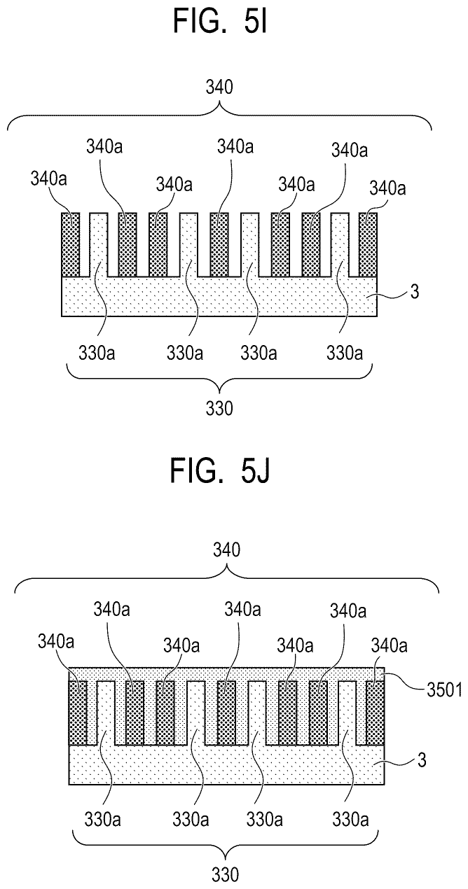

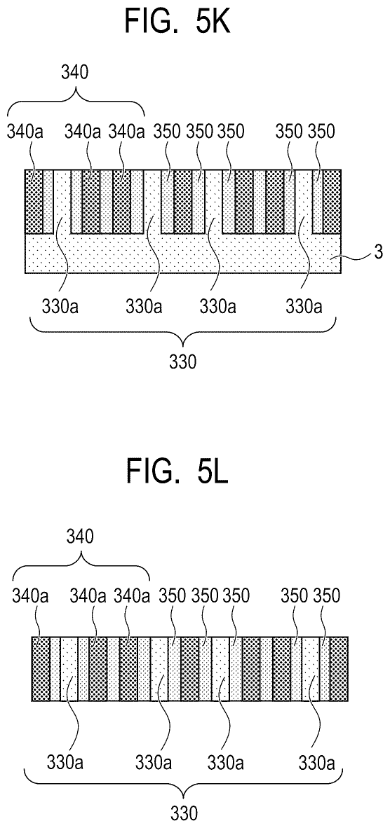

Next, a method of manufacturing the optical element 100 according to the present embodiment is described with reference to FIG. 5A to FIG. 5L. FIG. 5A to FIG. 5L are sectional views for illustrating steps of the method of manufacturing the optical element 100 according to the present embodiment.

First, as illustrated in FIG. 5A, the temporary substrate 3 to be used in forming of the optical element 100 is prepared. A material having a predetermined shape such as a board shape, a sheet shape, or the like may be prepared as the temporary substrate 3. The same material as that of the substrate 2 in the first embodiment may be prepared as the temporary substrate 3.

Next, the first metaatom group 330 is shaped on a surface of the temporary substrate 3 and a temporary foundation surface for shaping the second metaatom group 340 and the metaatom 350 is concurrently formed on the surface of the temporary substrate 3 by processing the surface of the temporary substrate 3. In this processing step, removal by etching is preferred to be used to process the temporary substrate 3. The processing step of processing the temporary substrate 3 with the use of removal by etching is specifically as follows.

First, as illustrated in FIG. 5B, a positive photoresist 402 is applied to a surface of the prepared temporary substrate 3.

Next, the photoresist 402 is exposed to light, with an exposure apparatus, above a surrounding portion of a portion of the temporary substrate 3 that becomes the first metaatoms 330a which form the first metaatom group 330. At the same time, in this exposure, the photoresist 402 is exposed to light above a portion of the temporary substrate 3 that becomes the temporary foundation surface for the second metaatom group 340 and for the metaatom 350. This increases solubility of the photoresist 402 above those portions. Next, portions of the photoresist 402 that have been increased in solubility by exposure to light are removed with a solvent, and development is executed. In this manner, a pattern is transferred onto the photoresist 402 and development is executed by photolithography. The photoresist 402 onto which the pattern has been transferred has a covering pattern corresponding to the first metaatoms 330a which form the first metaatom group 330. Note that the step of forming a pattern in the photoresist 402 is not limited to a step by photolithography, and may be a step of forming a pattern in the photoresist 402 by other methods such as imprinting or the like. The photoresist 402 with a pattern formed therein is thus formed by photolithography, imprinting, or the like as a mask to be used in the next step, which is etching.

The photoresist 402 with a pattern formed therein is then used as a mask to engrave the temporary substrate 3 with use of a processing method such as ion beam etching, reactive ion etching, or the like. Thus, as illustrated in FIG. 5C, the first metaatom group 330 is shaped on the surface of the temporary substrate 3 and the temporary foundation surface for shaping the second metaatom group 340 and the metaatom 350 is concurrently formed on the surface of the temporary substrate 3. The remaining photoresist 402 is then removed as illustrated in FIG. 5D.

Next, as illustrated in FIG. 5E, a positive photoresist is applied again as a photoresist 403 so as to cover the processed surface of the temporary substrate 3.

The photoresist 403 is next exposed to light, with the exposure apparatus, above a portion for forming the second metaatoms 340a which is included in the temporary foundation surface for shaping the second metaatom group 340 in the temporary substrate 3. This increases solubility of the photoresist 403 above this portion. Next, a portion of the photoresist 403 that has been increased in solubility by exposure to light is removed with a solvent, and development is executed. In this manner, as illustrated in FIG. 5F, a pattern is transferred onto the photoresist 403 and development is executed by photolithography. The photoresist 403 onto which the pattern has been transferred has an opening pattern that includes opening portions 4031 corresponding to the second metaatoms 340a which form the second metaatom group 340. Note that the step of forming a pattern in the photoresist 403 is not limited to a step by photolithography, and may be a step of forming a pattern in the photoresist 403 by other methods such as imprinting or the like. The photoresist 403 with a pattern formed therein is thus formed by photolithography, imprinting, or the like as a mask to be used in the next step, which is film forming.

Next, as illustrated in FIG. 5G, a film 3401 is formed from a material for forming the second metaatoms 340a of the second metaatom group 340 to fill the opening portions 4031 developed in the photoresist 403 with a pattern formed therein. Methods such as CVD, ALD, dipping, spin coating, and the like are usable to form the film 3401.

Next, as illustrated in FIG. 5H, the film 3401 and the photoresist 403 are polished by CMP or other methods until the first metaatoms 330a are reached, to thereby level the metasurface 300. The second metaatoms 340a made from the film 3401 which fills the opening portions 4031 are thus formed.

Next, as illustrated in FIG. 5I, the photoresist 403 remaining on the temporary substrate 3 is removed with a solvent.

Next, as illustrated in FIG. 5J, a film 3501 is formed from a material that becomes the metaatom 350. The film 3501 thus fills spaces between one of the first metaatoms 330a and another of the first metaatoms 330a, between one of the second metaatoms 340a and another of the second metaatoms 340a, and between one of the first metaatoms 330a and one of the second metaatoms 340a. As is the case for the film 3401, methods such as CVD, ALD, dipping, spin coating, and the like are usable to form the film 3501. The reason methods such as CVD, ALD, dipping, spin coating, and the like are usable to form the film 3501 as is the case for the film 3401 is because this, too, is a step in which a film is formed in opening portions to fill the opening portions.

Next, as illustrated in FIG. 5K, the film 3501 is polished by CMP or other methods until the first metaatoms 330a are reached, to thereby level the metasurface 300. The metaatom 350 made from the film 3501 is thus formed.

Next, the photoresist remaining on the temporary substrate 3 is removed with a solvent. Functional films such as a protective film and an anti-reflection film may then be provided as appropriate on the metasurface 300.

Next, as illustrated in FIG. 5L, the temporary substrate 3 is polished from a surface side opposite to the surface on which the metasurface 300 including the first metaatom group 330, the second metaatom group 340, and the metaatom 350 has been formed. The temporary substrate 3 can be kept polished until the materials of the metaatoms that have been provided in the previous steps are exposed.

The optical element 100 obtained in the manner described above may then be cleaved to a desired size. The optical element 100 according to the present embodiment can be manufactured in this manner.

Thus, according to the present embodiment, the number of selectable materials for forming the first metaatom group 330 can be increased because the first metaatom group 330 is formed by the same material composition as the material composition of the substrate 2 with the use of the temporary substrate 3. The present embodiment can accordingly improve the degree of freedom in designing of the metasurface 300. With the degree of freedom in designing of the metasurface 300 improved, application of the optical element 100 including the metasurface 300 can be expanded to a broad range of uses and products.

### EXAMPLES

Next, the optical element according to the present disclosure is described in detail with use of Examples. Example 1 to Example 4 are Examples of the optical element 100 according to the first embodiment. In Example 1 to Example 4, the optical element 100 including the metasurface 300 was manufactured by preparing and processing the substrate 2 by following the manufacturing method illustrated in FIG. 3A to FIG. 3I. In Example 1 and Example 3, the material of the substrate 2 was optical glass S-TIH57 (a product of OHARA Corporation). In Example 2 and Example 4, the material of the substrate 2 was optical glass S-LAL61Q (a product of OHARA Corporation). The product S-TIH57 was high-refractive-index glass containing Ti, and S-LAL61Q was high-refractive index glass containing La.

In Example 1 to Example 4, the positive photoresist 400 was applied by spin coating to the prepared substrate 2, was patterned with the use of photolithography, and a patterned portion of the photoresist 400 was removed with the use of a solvent. The substrate 2 was then etched by ion beam etching to process a part of the substrate 2 into a large number of pillar-like portions and concave portions enclosing the pillar-like portions. This formed the first metaatom group 310 which included a plurality of first metaatoms 310a configured from the pillar-like portions. At the same time, in the concave portions created by etching the substrate 2, flat portions for providing the second metaatom group 320 in a later step were formed in the substrate 2. The photoresist 400 was next removed with a peeling liquid, and a positive photoresist was applied again as the photoresist 401 to the processed surface of the substrate 2. Next, the photoresist 401 was patterned with the use of lithography, and a patterned portion of the photoresist 401 was removed with the use of a solvent. A silicon nitride film (Si₃N₄ film) was formed by ALD as the film 3201 to fill the opening portions 4011 which were provided in the photoresist 401 in previous steps and which correspond to the second metaatom group 320. The second metaatom group 320 including the plurality of second metaatoms 320a which were configured from the Si₃N₄ film was thus formed. The surface covered with the Si₃N₄ film was then polished by CMP until the first metaatom group 310 and the photoresist 401 remaining on the substrate 2 were exposed. Next, the exposed photoresist 401 was removed with a peeling liquid. The optical element 100 of Example 1 to Example 4 was manufactured in this manner.

Note that, in Example 1 to Example 4, the first metaatom 310a forming the first metaatom group 310 and the second metaatoms 320a forming the second metaatom group 320 had a columnar shape. In Example 1 and Example 2, the columnar first metaatoms 310a and second metaatoms 320a had a diameter of 300 nm. In Example 3 and Example 4, the columnar first metaatoms 310a and second metaatoms 320a had a diameter of 400 nm.

In the optical element 100 of Example 1 to Example 4, the first metaatom group 310 configured from the material of the substrate 2 and the second metaatom group 320 configured from the Si₃N₄ film which was the film 3201 formed on the substrate 2 were provided. A propagation phase delay effect was exhibited in the metasurface 300 in the optical element 100 of Example 1 to Example 4 by combining the first metaatom group 310 and the second metaatom group 320 with air in the atmospheric air which is a medium relatively lower in refractive index than materials forming the metaatom groups 310 and 320.

Ratios of refractive indices in Example 1 to Example 4 are shown in Table 1 with respect to wavelengths of 435.83 nm, 587.56 nm, and 706.52 nm of light. A ratio of a refractive index here means a ratio n₂/n¹ of a relative refractive index n₂ of the second metaatoms 320a with respect to air, to a relative refractive index n₁ of the first metaatoms 310a with respect to air.

TABLE 1

| | | Example | Example | Example | Example |
|---|---|---|---|---|---|
| | Wavelength | 1 | 2 | 3 | 4 |
| Refractive | 435.83 nm | 1.015 | 1.134 | 1.019 | 1.161 |
| index | 587.56 nm | 1.02 | 1.105 | 1.026 | 1.129 |
| | 706.52 nm | 1.02 | 1.01 | 1.025 | 1.112 |

| | | | | |
|---|---|---|---|---|
| Metaatom | 300 nm | 300 nm | 400 nm | 400 nm |
| column diameter | | | | |

Example 1 and Example 3 indicate that the use of S-TIH57 as the material of the first metaatoms 310a increases the degree of freedom in design in an optical design that demands a refractive index slightly lower than that of the second metaatoms 320a which are Si₃N₄ over a wide wavelength range.

Example 2 indicates that the use of S-LAL61Q as the material of the first metaatoms 310a increases the degree of freedom in design in an optical design that demands aberration correction on a relatively short wavelength side with respect to the second metaatoms 320a which are Si₃N₄.

Example 4 indicates that the use of S-LAL61Q as the material of the first metaatoms 310a increases the degree of freedom in design in an optical design that demands a refractive index lower than that of the second metaatoms 320a which are Si₃N₄, by approximately 10%, over a wide wavelength range.

In an optical design demanded for an end product, selectability of diverse effects is very important. It has been confirmed that, in Example 1 to Example 4, diverse effects are selectable as a result of the improved degree of freedom in designing of the metasurface 300 in the optical element 100.

### Third Embodiment

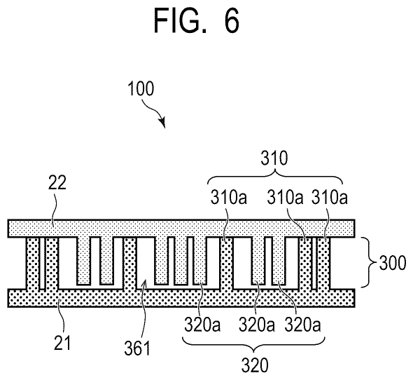

An optical element and a method of manufacturing an optical element according to a third embodiment of the present disclosure are described with reference to FIG. 6 to FIG. 8. Note that components similar to those of the optical element according to the first and second embodiments are denoted by the same reference symbols, and descriptions thereof are omitted or simplified.

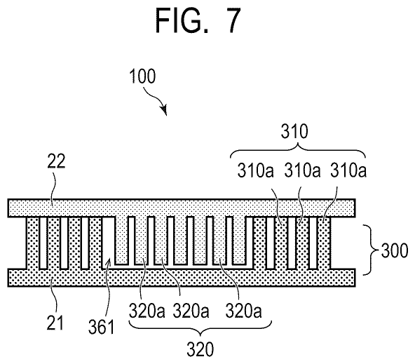

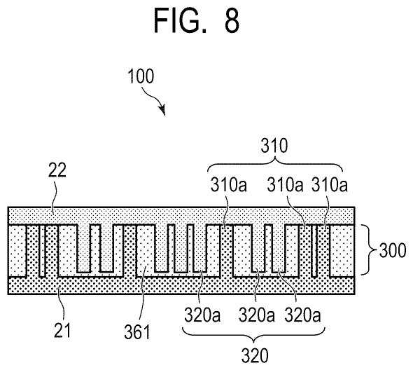

First, a configuration of the optical element according to the present embodiment is described with reference to FIG. 6 to FIG. 8. FIG. 6 is a sectional view for illustrating the optical element 100 according to the present embodiment. FIG. 7 is a sectional view for illustrating another example of a configuration related to metaatoms in the optical element 100 according to the present embodiment. FIG. 8 is a sectional view for illustrating an example in which a peripheral region 361 is filled with a solid in the optical element 100 according to the present embodiment.

As illustrated in FIG. 6, the optical element 100 according to the present embodiment includes a first substrate 21 and a second substrate 22. The second substrate 22 is placed so as to oppose the first substrate 21. The optical element 100 according to the present embodiment further includes the metasurface 300 formed between the first substrate 21 and the second substrate 22. The first substrate 21 and the second substrate 22 are joined to each other so that the metasurface 300 is interposed between the two.

The metasurface 300 is configured from a plurality of metaatom groups and, specifically, has at least a first metaatom group 310 and a second metaatom group 320, which differs from the first metaatom group 310. A metaatom group is a group of metaatoms. A metaatom is an artificially provided structural object, and has a size sufficiently small with respect to a wavelength of target light that is a target of the optical element 100. The first metaatom group 310 is a group of first metaatoms 310a. The second metaatom group 320 is a group of second metaatoms 320a. Note that the first substrate 21 is portions immediately below the plurality of first metaatoms 310a, and portions that connect the underlying portions to one another. Also not that the second substrate 22 is portions immediately below the plurality of second metaatoms 320a, and portions that connect the underlying portions to one another.

The first metaatom group 310 is formed on a surface of the first substrate 21 that is opposed to the second substrate 22. Top surfaces of the first metaatoms 310a which form the first metaatom group 310 may be opposed, across a gap, to a surface of the second substrate 22 that is opposed to the first substrate 21, or may be joined to the surface of the second substrate 22 that is opposed to the first substrate 21. The second metaatom group 320 is formed on the surface of the second substrate 22 that is opposed to the first substrate 21. Top surfaces of the second metaatoms 320a which form the second metaatom group 320 may be opposed, across a gap, to the surface of the first substrate 21 that is opposed to the second substrate 22, or may be joined to the surface of the first substrate 21 that is opposed to the second substrate 22.

The metasurface 300 includes the peripheral region 361. That is, spaces between one of the first metaatom 310a and another of the first metaatoms 310a, between one of the first metaatoms 310a and one of the second metaatoms 320a, and between one of the second metaatoms 320a and another of the second metaatoms 320a are each the peripheral region 361. The peripheral region 361 is filled with, for example, air. The air filling the peripheral region 361 is a medium through which the target light of the optical element 100 can be transmitted, and is a low-refractive index medium lower in refractive index than the first metaatoms 310a and the second metaatoms 320a with respect to the target light of the optical element 100. The metasurface 300 may include, in the peripheral region 361, instead of air, a medium through which the target light of the optical element 100 can be transmitted and which is a low-refractive index medium lower in refractive index than the first metaatoms 310a and the second metaatoms 320a with respect to the target light.

Note that the configuration related to the metaatoms in the optical element 100 according to the present embodiment, such as a positional relationship between the first metaatom group 310 and the second metaatom group 320, and arrangement of the first metaatoms 310a and the second metaatoms 320a, is not limited to the example illustrated in FIG. 6. The configuration related to the metaatoms in the optical element 100 according to the present embodiment may differ from the configuration illustrated in FIG. 6, as in the example illustrated in FIG. 7.

The plurality of metaatom groups in the optical element 100 are distinguished from one another by material compositions that configure the respective metaatoms. That is, the first metaatoms 310a which form the first metaatom group 310 and the second metaatoms 320a which form the second metaatom group 320 are configured by material compositions having refractive indices different from each other with respect to the target light that is the target of the optical element 100. The first metaatom group 310 and the second metaatom group 320 are thus configured by material compositions having refractive indices different from each other with respect to the target light of the optical element 100. For example, the refractive index due to the material composition of the first metaatom group 310 is lower than the refractive index due to the material composition of the second metaatom group 320 with respect to target light having a certain wavelength range.

The material composition of the first metaatom group 310 is the same as a material composition of the first substrate 21. The material composition of the second metaatom group 320 is the same as a material composition of the second substrate 22. Here, having the same material composition means that material compositions of most portions or main portions that dictate optical characteristics of two objects of interest are the same as each other. Differences due to superficial or internal transmutation or the like that is caused in the objects by processing, treatment, or the like do not keep the objects from having the same material composition.

Action of a metasurface on light varies for different wavelengths, different incident angles, and different manners of polarization. Accordingly, optimization for a specific incidence condition is possible, whereas it is difficult to accommodate a wide range of incidence conditions. This is why most of the optical elements having a metasurface that are currently in the market are ones with limited incidence conditions such as a sensor using a monochromatic laser.

One of reasons for the difficulty of accommodating a wide range of incidence conditions is a low degree of freedom in designing of a metasurface due to smallness of the number of methods of forming a metasurface and the number of materials that are selectable as a material of a metasurface. There is a wide range of needs, including an achromatic lens which accommodates a wide spectrum range and a large field-of-view lens which accommodates a wide range of incident angles, for optical elements having a metasurface, and improvement of the degree of freedom in designing of a metasurface is accordingly demanded.

With this regard, in the present embodiment, the material composition of the first metaatom group 310 which is at least one metaatom group out of the plurality of metaatom groups in the optical element 100 is the same as the material composition of the first substrate 21. In addition, in the present embodiment, the material composition of the second metaatom group 320 which is at least one metaatom group out of the plurality of metaatom groups is the same as the material composition of the second substrate 22. There are many materials to choose from for the first substrate 21 and the second substrate 22. Having the same material composition as that of such first substrate 21, the first metaatom group 310 also has many materials that are selectable as its material. Further, having the same material composition as that of such second substrate 22, the second metaatom group 320 also has many materials that are selectable as its material. Thus, according to the present embodiment, the degree of freedom in designing of the metasurface 300 can be improved.

Further, the first metaatom group 310 which has the same material composition as that of the first substrate 21 is more preferred to be formed continuously from the first substrate 21. The second metaatom group 320 which has the same material composition as that of the second substrate 22 is more preferred to be formed continuously from the second substrate 22. In those cases, the first metaatom group 310 and the second metaatom group 320 can be formed by processing the first substrate 21 and the second substrate 22, respectively. The material compositions of the first metaatom group 310 and the second metaatom group 320 can accordingly be selected without taking what film forming method is to be used into account. As a result, wider ranges of options for the material compositions of the first metaatom group 310 and the second metaatom group 320 become available, and the degree of freedom in designing of the metasurface 300 can accordingly be improved. Note that being continuously formed here means that, for each of the first metaatom group 310 and the second metaatom group 320, the metaatom group and the substrate are a unitary structural object without a boundary, and that the metaatom group is configured from a part of a surface shape of the substrate.

A specific description is given below on the first substrate 21, the second substrate 22, the metasurface 300, the first metaatoms 310a, and the second metaatoms 320a of the optical element 100 according to the present embodiment.

The first substrate 21 and the second substrate 22 are members such as substrates that are transmissive with respect to light of a desired wavelength that is a target wavelength of the optical element 100, and that serve as foundations for configuring the first metaatom group 310 and the second metaatom group 320, respectively, on surfaces. Materials, sizes, and thicknesses suitable for a use of the optical element 100 may be selected for the first substrate 21 and the second substrate 22.

For example, in the case in which the target light of the optical element 100 is visible light having a wavelength of 400 nm or more and 800 nm or less, materials containing a metal oxide are preferred to be selected as the materials of the first substrate 21 and the second substrate 22. Specifically, it is preferred in this case to select, as the material of at least one of the first substrate 21 and the second substrate 22, a material containing at least one type of oxide out of oxides of La, Nb, W, Ti, K, Na, and Li. Alternatively, it is preferred in this case to select, as the material of at least one of the first substrate 21 and the second substrate 22, a material that is a resin containing cycloolefin, or a resin containing polyolefin. When performance as the optical element 100 is taken into account, the first substrate 21 and the second substrate 22 are preferred to have, at least, a transmittance of 60% or more with respect to the target light of the optical element 100.

In contrast, in a case in which the target light of the optical element 100 has a wavelength longer than that of visible light, it is preferred to select, as the material of at least one of the first substrate 21 and the second substrate 22, a material containing at least one type out of polycrystalline silicon, Ge, ZnSe, SeS, ZnS, CaF₂, sapphire, and chalcogenide glass.

In a case in which the target light of the optical element 100 has a wavelength shorter than that of visible light, it is preferred to select, as the material of at least one of the first substrate 21 and the second substrate 22, a material containing at least one type of fluoride out of fluorides of Al, Mg, Ca, Ba, and Sr. Note that the case in which the target light has a wavelength shorter than that of visible light is, specifically, a case in which ultraviolet light having a wavelength of 257 nm or more and 360 nm or less is the target.

Others selectable as the material of at least one of the first substrate 21 and the second substrate 22 include an oxide, a nitride, or an oxynitride of one type of element out of Si, Al, Ti, Hf, Ta, and Nb, depending on the use.

Depending on the use of the optical element 100, visible light and light having a wavelength longer than that of visible light may be set as target light, or visible light and light having a wavelength shorter than that of visible light may be set as target light. For example, a material optimum for visible light and a material optimum for light having a wavelength shorter than that of visible light may be selected as the material of the first substrate 21 and the material of the second substrate 22, respectively.

Note that the first substrate 21 may have a functional film on a surface on an opposite side from the metasurface 300. The second substrate 22 may have a functional film on a surface on an opposite side from the metasurface 300. Those functional films are, for example, protective films, anti-reflection films, and the like.

The metasurface 300 is an optical surface provided on surfaces of the first substrate 21 and the second substrate 22 that are opposed to each other. The surface of the first substrate 21 includes the first metaatom group 310, and the surface of the second substrate 22 includes the second metaatom group 320. The first metaatom group 310 and the second metaatom group 320 are configured by material compositions different from each other in refractive index with respect to the target light of the optical element 100.

The first metaatom group 310 is a group of a plurality of first metaatoms 310a. The second metaatom group 320 is a group of a plurality of second metaatoms 320a.

The metasurface 300 is preferred to include three or more types of media through which the target light of the optical element 100 can be transmitted and propagated. In the case of the present embodiment, the metasurface 300 includes three types of media which are the first metaatom group 310 as the first medium, the second metaatom group 320 as the second medium, and the air or another medium which fills the peripheral region 361 as the third medium.

The first metaatom group 310 and the second metaatom group 320 have the same material compositions as those of the first substrate 21 and the second substrate, respectively, and, as is the case for the first substrate 21 and the second substrate 22, a material suitable for the wavelength of the target light of the optical element 100 is selectable for each of the first metaatom group 310 and the second metaatom group 320. That is, in the case in which the target light of the optical element 100 is visible light having a wavelength of 400 nm or more and 800 nm or less, a material containing a metal oxide is preferred to be selected as the material of at least one of the first metaatom group 310 and the second metaatom group 320. Specifically, it is preferred in this case to select, as the material of at least one of the first metaatom group 310 and the second metaatom group 320, a material containing at least one type of oxide out of oxides of La, Nb, W, Ti, K, Na, and Li. Alternatively, a material containing one of a resin that contains cycloolefin and a resin that contains polyolefin is selectable in this case as the material of at least one of the first metaatom group 310 and the second metaatom group 320.

In contrast, in the case in which the target light of the optical element 100 has a wavelength longer than that of visible light, it is preferred to select, as the material of at least one of the first metaatom group 310 and the second metaatom group 320, a material containing at least one type out of polycrystalline silicon, Ge, ZnSe, SeS, ZnS, CaF₂, sapphire, and chalcogenide glass.

In the case in which the target light of the optical element 100 has a wavelength shorter than that of visible light, the material of at least one of the first metaatom group 310 and the second metaatom group 320 may be selected from materials containing at least one type of fluoride out of fluorides of Al, Mg, Ca, Ba, and Sr.

Others selectable as the material of at least one of the first metaatom group 310 and the second metaatom group 320 include an oxide, a nitride, or an oxynitride of one type of element out of Si, Al, Ti, Hf, Ta, and Nb.

As the third medium which fills the peripheral region 361 in the metasurface 300 and through which the target light can be transmitted, air, water, vacuum, or the like is selectable. In a case in which the peripheral region 361 is filled with a solid as illustrated in FIG. 8, a plastic resin such as a thermoplastic resin, a Si oxide, MgF₂, or the like is selectable as the third medium through which the target light can be transmitted. The third medium differs from the first metaatom group 310 and the second metaatom group 320 in refractive index, and is preferred to be a low-refractive index medium lower in refractive index with respect to the target light than the metal compositions that configure the first metaatoms 310a and the second metaatoms 320a.

The metasurface 300 can be designed so as to exert a refraction effect via propagation phase delay, geometrical phase delay, or the like on light in a desired wavelength range that is the target light of the optical element 100, by a combination of the first metaatom group 310, the second metaatom group 320, and the third medium.

The first metaatoms 310a are artificial structural objects each having a pillar structure, and form the first metaatom group 310. Values suitable for the wavelength of the target light that is the target of the optical element 100 are selectable for a sectional shape and a height of the first metaatoms 310a and a distance between two of the first metaatoms 310a. In principle, the first metaatoms 310a each have a size sufficiently small with respect to the wavelength of the target light that is the target of the optical element 100.

The first metaatoms 310a which form the first metaatom group 310 are preferred to have the same material composition as that of the first substrate 21. It is more preferred for the first metaatoms 310a to be a structural object unitary with the first substrate 21, without a boundary to the first substrate 21, and be a part of the surface shape of the first substrate 21. That is, the first metaatoms 310a are more preferred to be a structural object formed by processing the surface of the first substrate 21.

The second metaatoms 320a are artificial structural objects each having a pillar structure, and form the second metaatom group 320. Values suitable for the wavelength of the target light that is the target of the optical element 100 are selectable for a sectional shape and a height of the second metaatoms 320a and a distance between two of the second metaatoms 320a. In principle, the second metaatoms 320a each have a size sufficiently small with respect to the wavelength of the target light that is the target of the optical element 100.

The second metaatoms 320a which form the second metaatom group 320 are structural objects formed on the second substrate 22 by a material composition having a refractive index different from that of the first metaatoms 310a which form the first metaatom group 310. That is, the second metaatoms 320a are structural objects formed on the second substrate 22 by a material composition having a refractive index different from that of the first substrate 21. The second metaatoms 320a are preferred to have the same material composition as that of the second substrate 22. The second metaatoms 320a are more preferred to be a structural object unitary with the second substrate 22, without a boundary to the second substrate 22, and be a part of a surface shape of the second substrate 22. That is, the second metaatoms 320a are more preferred to be a structural object formed by processing the surface of the second substrate 22.

Note that the first metaatoms 310a and the second metaatoms 320a are each not limited to structural objects having a pillar structure, and may be structural objects having other convex structures.

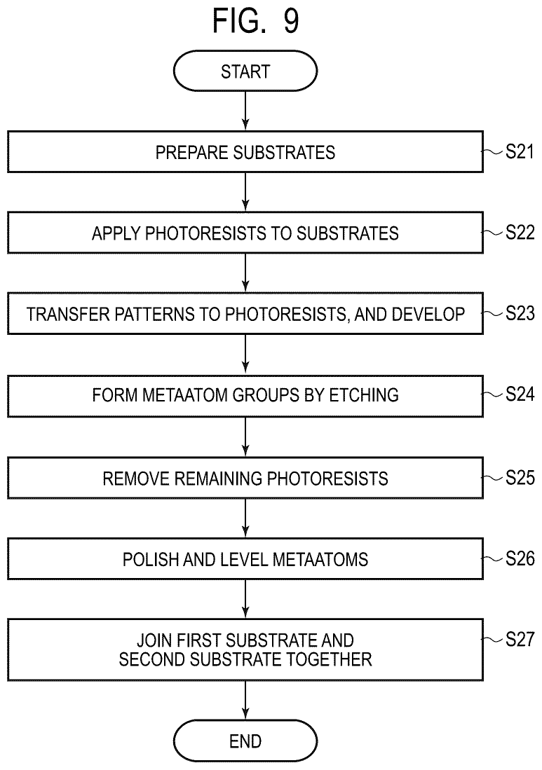

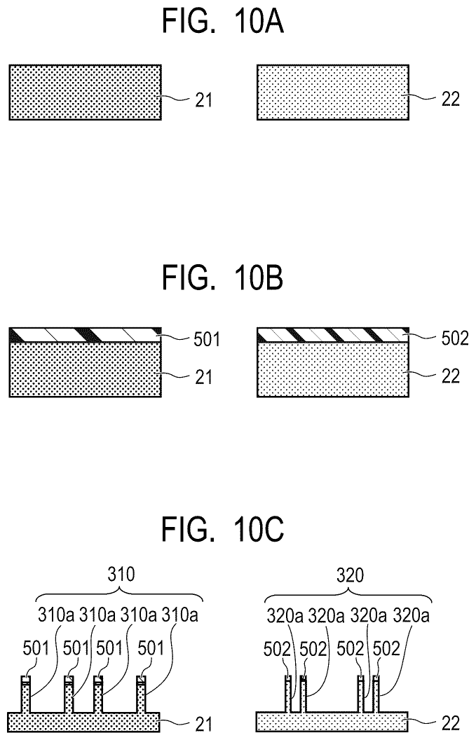

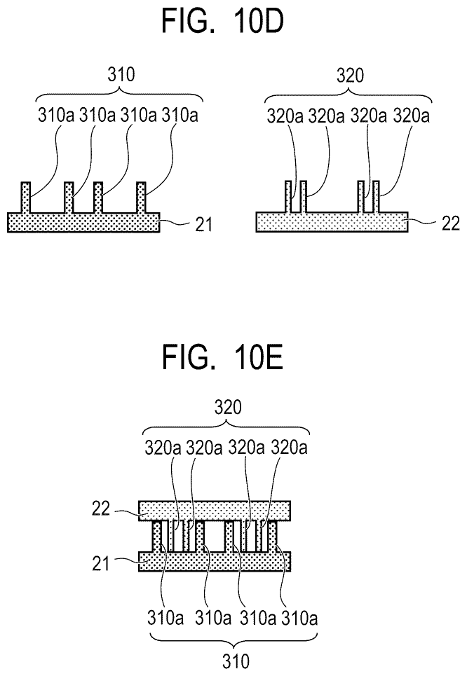

A method of manufacturing the optical element 100 according to the present embodiment is described next with reference to FIG. 9 to FIG. 10E. FIG. 9 is a flow chart for illustrating an example of manufacturing steps in the method of manufacturing the optical element 100 according to the present embodiment. FIG. 10A to FIG. 10E are sectional views for illustrating steps of an example of the method of manufacturing the optical element 100 according to the present embodiment.

First, as illustrated in FIG. 10A, the first substrate 21 and the second substrate 22 to be used for forming of the optical element 100 are prepared (Step S21). Materials having a predetermined shape such as a board shape or a sheet shape may be prepared as the first substrate 21 and the second substrate 22.

Next, the first metaatom group 310 and the second metaatom group 320 are shaped on a surface of the first substrate 21 and a surface of the second substrate 22, respectively, by processing the surface of the first substrate 21 and the surface of the second substrate 22. In those processing steps, removal by etching is preferred to be used to process the first substrate 21 and the second substrate 22. The processing steps of processing the first substrate 21 and the second substrate 22 with the use of removal by etching are specifically as follows. Note that the processing steps including Step S22 to Step S26 described below are executable at any timing with respect to the first substrate 21 and the second substrate 22. That is, which of the processing step that includes Step S22 to Step S26 for the first substrate 21 and the processing step that includes Step S22 to Step S26 for the second substrate 22 is executed first does not matter, and may also be executed concurrently.

First, as illustrated in FIG. 10B, positive photoresists 501 and 502 are applied to surfaces of the prepared first substrate 21 and second substrate 22, respectively (Step S22).

Next, the photoresist 501 is exposed to light, with an exposure apparatus, in a portion to be a surrounding portion of a portion of the first substrate 21 that becomes the first metaatoms 310a which form the first metaatom group 310. The photoresist 502 is also exposed to light, with the exposure apparatus, in a portion to be a surrounding portion of a portion of the second substrate 22 that becomes the second metaatoms 320a which form the second metaatom group 320. This increases solubility of the photoresists 501 and 502 in those portions. Next, the portion of the photoresist 501 that has been increased in solubility by exposure to light is removed with a solvent, and development is executed. The portion of the photoresist 502 that has been increased in solubility by exposure to light is removed with a solvent, and development is executed. In this manner, patterns are transferred onto the photoresists 501 and 502 and development is executed by photolithography (Step S23). The photoresist 501 onto which the pattern has been transferred has a covering pattern corresponding to the first metaatoms 310a which form the first metaatom group 310. The photoresist 502 onto which the pattern has been transferred has a covering pattern corresponding to the second metaatoms 320a which form the second metaatom group 320. Note that the steps of forming patterns in the photoresists 501 and 502 are not limited to steps by photolithography, and may be steps of forming patterns in the photoresists 501 and 502 by other methods such as imprinting or the like. The photoresists 501 and 502 with patterns formed therein are thus formed by photolithography, imprinting, or the like as masks to be used in the next step, which is etching.

The photoresist 501 with a pattern formed therein is then used as a mask to engrave the first substrate 21 with use of a processing method such as ion beam etching, reactive ion etching, or the like. The photoresist 502 with a pattern formed therein is also used as a mask to engrave the second substrate 22 with use of a processing method such as ion beam etching, reactive ion etching, or the like. Thus, as illustrated in FIG. 10C, the first metaatom group 310 is shaped on the surface of the first substrate 21, and the second metaatom group 320 is shaped on the surface of the second substrate 22 (Step S24). The remaining photoresists 501 and 502 are then removed as illustrated in FIG. 10D (Step S25).

Next, a vertex surface of the formed first metaatom group 310 is polished by CMP or other methods to have a leveled height. A vertex surface of the formed second metaatom group 320 is also polished by CMP or other methods to have a leveled height (Step S26).

In this manner, through the steps of processing the first substrate 21 and the steps of processing the second substrate 22, the first substrate 21 having the first metaatom group 310 on the surface and the second substrate 22 having the second metaatom group 320 on the surface are prepared, respectively.

Next, the surface of the first substrate 21 that has the first metaatom group 310 and the surface of the second substrate 22 that has the second metaatom group 320 are opposed to each other to join the first substrate 21 and the second substrate 22 as illustrated in FIG. 10E (Step S27). This joins the first substrate 21 and the second substrate 22 to each other so that the metasurface 300 including the first metaatom group 310 and the second metaatom group 320 is interposed between the first substrate 21 and the second substrate 22. Surface activated bonding (SAB) or the like, for example, is usable for the joining of the first substrate 21 and the second substrate 22.

The optical element 100 according to the present embodiment can be manufactured in this manner. The manufactured optical element 100 may be cleaved to suit requirements of a use.

In the present embodiment, the first metaatom group 310 and the second metaatom group 320 are thus formed by processing the first substrate 21 and the second substrate 22, respectively, which have two types of material compositions different from each other. Accordingly, the present embodiment is capable of increasing the number of materials selectable for forming of the metasurface 300, with the result that the degree of freedom in designing of the metasurface 300 is improved. With the degree of freedom in designing of the metasurface 300 improved, application of the optical element 100 including the metasurface 300 can be expanded to a broad range of uses and products.

### Fourth Embodiment

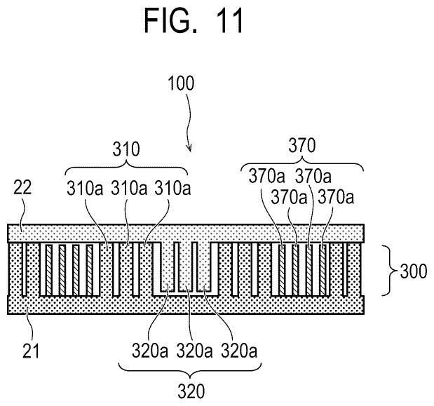

An optical element and a method of manufacturing an optical element according to a fourth embodiment of the present disclosure are described with reference to FIG. 11. Note that components similar to those of the optical element according to the first to third embodiments are denoted by the same reference symbols, and descriptions thereof are omitted or simplified.

A basic configuration of the optical element 100 according to the present embodiment is the same as the configuration of the optical element 100 according to the third embodiment. The optical element 100 according to the present embodiment differs from the optical element 100 according to the third embodiment in that a third metaatom group 370 is further included. A configuration of the optical element 100 according to the present embodiment is described below with reference to FIG. 11. FIG. 11 is a sectional view for illustrating the optical element 100 according to the present embodiment.

As illustrated in FIG. 11, the optical element 100 according to the present embodiment includes the first substrate 21 and the second substrate 22. The second substrate 22 is placed so as to oppose the first substrate 21. The optical element 100 according to the present embodiment further includes the metasurface 300 formed between the first substrate 21 and the second substrate 22. The first substrate 21 and the second substrate 22 are joined to each other so that the metasurface 300 is interposed between the two.

The metasurface 300 is configured from a plurality of metagroups. Specifically, the metasurface 300 in the present embodiment includes, at least, the first metaatom group 310 and the second metaatom group 320 different from the first metaatom group 310. The metasurface 300 in the present embodiment further includes the third metaatom group 370, which differs from the first metaatom group 310 and the second metaatom group 320. The first metaatom group 310 is a group of first metaatoms 310a. The second metaatom group 320 is a group of second metaatoms 320a. The third metaatom group 370 is a group of third metaatoms 370a.

The first metaatom group 310 is formed on a surface of the first substrate 21 that is opposed to the second substrate 22. The second metaatom group 320 is formed on a surface of the second substrate 22 that is opposed to the first substrate 21. The third metaatom group 370 is formed on a surface of the first substrate 21 that is on the same side as the first metaatom group 310 and that has no first metaatom group 310 formed thereon. The third metaatom group 370 may be formed on a surface of the second substrate 22 that is on the same side as the second metaatom group 320 and that has no second metaatom group 320 formed thereon.

In the present embodiment also, the plurality of metaatom groups in the optical element 100 are distinguished from one another by material compositions that configure the respective metaatoms. To elaborate, the first metaatoms 310a which form the first metaatom group 310, the second metaatoms 320a which form the second metaatom group 320, and the third metaatoms 370a which form the third metaatom group 370 are configured by the following material compositions. That is, the first metaatoms 310a, the second metaatoms 320a, and the third metaatoms 370a are configured by material compositions different from one another in refractive index with respect to target light that is a target of the optical element 100.

In addition, the material composition of the first metaatom group 310 is the same as the material composition of the first substrate 21 as in the third embodiment. Further, the material composition of the second metaatom group 320 is the same as the material composition of the second substrate 22 as in the third embodiment.

Further, the first metaatom group 310 which has the same material composition as that of the first substrate 21 is more preferred to be formed continuously from the first substrate 21, as in the third embodiment. The second metaatom group 320 which has the same material composition as that of the second substrate 22 is more preferred to be formed continuously from the second substrate 22, as in the third embodiment. In those cases, the first metaatom group 310 and the second metaatom group 320 can be formed by processing the first substrate 21 and the second substrate 22, respectively. The material compositions of the first metaatom group 310 and the second metaatom group 320 can accordingly be selected without taking what film forming method is to be used into account.

In the present embodiment, the third metaatom group 370 is formable by, for example, processing a film obtained by a film forming method. Specifically, in the manufacturing method illustrated in FIG. 9, the third metaatom group 370 may be formed after Step S26 and before Step S27, on a surface of the first substrate 21 that is on the same side as the first metaatom group 310 and that has no first metaatom group 310 formed thereon. The third metaatom group 370 is formable with the use of a film forming method by, for example, the same method that is used to form the second metaatom group 320 in the method of manufacturing the optical element 100 according to the first embodiment. Note that the third metaatom group 370 may be formed on a surface of the second substrate 22 that is on the same side as the second metaatom group 320 and that has no second metaatom group 320 formed thereon.

The third metaatom group 370 has a material composition different from those of the first metaatom group 310 and the second metaatom group 320, that is, a material composition different from those of the first substrate 21 and the second substrate 22.

In the present embodiment, as in the third embodiment, the material composition of the first metaatom group 310 which is at least one metaatom group out of the plurality of metaatom groups in the optical element 100 is the same as the material composition of the first substrate 21. In addition, in the present embodiment, the material composition of the second metaatom group 320 which is at least one metaatom group out of the plurality of metaatom groups is the same as the material composition of the second substrate 22, as in the third embodiment.

There are many materials to choose from for the first substrate 21 and the second substrate 22. Having the same material composition as that of such first substrate 21, the first metaatom group 310 also has many materials that are selectable as its material. Further, having the same material composition as that of such second substrate 22, the second metaatom group 320 also has many materials that are selectable as its material. In addition, the third metaatom group 370 obtained by a film forming method is added in the present embodiment, and combinations of material compositions of the metaatom groups included in the metasurface 300 can accordingly be increased in number.

In the present embodiment, the first metaatom group 310 and the second metaatom group 320 are thus formed by processing the first substrate 21 and the second substrate 22, respectively, which have two types of material compositions different from each other. In addition, in the present embodiment, such first metaatom group 310 and second metaatom group 320 are combined with the third metaatom group 370 formed by a film forming method. Accordingly, the present embodiment is capable of increasing the number of materials selectable for forming of the metasurface 300 even more, with the result that the degree of freedom in designing of the metasurface 300 is improved further. With the degree of freedom in designing of the metasurface 300 improved, application of the optical element 100 including the metasurface 300 can be expanded to a broad range of uses and products. The products may be mirrorless cameras, smartphones, microscopes, and semiconductor exposure apparatus, which have optical systems to control the target light. The product may comprise a light emitting device which emits the target light. The light emitting device may be a light source or a display in the product. The product may comprise a light receiving device which receives the target light. The light receiving device may be an image sensor or a reticle in the product. Such device which emits or receives the target light may be used with the optical element 100 including the metasurface 300.

According to the present disclosure, the degree of freedom in designing of a metasurface can be improved.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-195334, filed Nov. 7, 2024, and Japanese Patent Application No. 2025-147823, filed Sep. 5, 2025, which are hereby incorporated by reference herein in their entirety.

What is claimed is:

1. An optical element comprising:
a substrate; and
a metasurface formed on the substrate,
wherein the metasurface includes a first metaatom through which light is capable of propagating, and a second metaatom through which light is capable of propagating,
wherein the second metaatom differs from the first metaatom in refractive index, and
wherein the first metaatom has the same material composition as a material composition of the substrate.

2. The optical element according to claim 1, wherein the first metaatom is formed continuously from the substrate.

3. The optical element according to claim 2, wherein the first metaatom is a processed form of the substrate.

4. The optical element according to claim 1,
wherein the metasurface includes a medium through which light is capable of propagating, and
wherein the medium differs from the first metaatom and the second metaatom in refractive index.

5. The optical element according to claim 4,
wherein the metasurface includes a void portion, and
wherein the medium is air filling the void portion.

6. The optical element according to claim 1, wherein the first metaatom and the second metaatom each have a pillar structure.

7. The optical element according to claim 1, wherein the substrate contains at least one type of oxide out of oxides of La, Nb, W, Ti, K, Na, and Li.

8. The optical element according to claim 1, wherein the substrate is a resin containing cycloolefin or a resin containing polyolefin.

9. The optical element according to claim 1, wherein the substrate has a transmittance of 60% or more with respect to light having a wavelength of 400 nm or more and 800 nm or less.

10. The optical element according to claim 1, wherein the substrate contains at least one type out of polycrystalline silicon, Ge, ZnSe, SeS, ZnS, CaF₂, sapphire, and chalcogenide glass.

11. The optical element according to claim 1, wherein the substrate contains at least one type of fluoride out of fluorides of Al, Mg, Ca, Ba, and Sr.

12. The optical element according to claim 1, wherein the substrate contains one of an oxide, a nitride, or an oxynitride of one type of element out of Si, Al, Ti, Hf, Ta, and Nb.

13. The optical element according to claim 1,
wherein the substrate includes:
a first substrate; and
a second substrate placed so as to oppose the first substrate,
wherein the metasurface is formed between the first substrate and the second substrate,
wherein the first metaatom is formed on a surface of the first substrate that is opposed to the second substrate,
wherein the second metaatom is formed on a surface of the second substrate that is opposed to the first substrate,
wherein the first metaatom has the same material composition as a material composition of the first substrate, and
wherein the second metaatom has the same material composition as a material composition of the second substrate.

14. The optical element according to claim 13, wherein the first metaatom is formed continuously from the first substrate.

15. The optical element according to claim 13, wherein the second metaatom is formed continuously from the second substrate.

16. The optical element according to claim 13,
wherein the metasurface includes a third metaatom formed on a surface of one of the first substrate or the second substrate, and
wherein the third metaatom has a material composition different from the material compositions of the first substrate and the second substrate.

17. The optical element according to claim 13,
wherein the first metasurface includes a low-refractive index medium through which light is capable of propagating, and
wherein the low-refractive index medium is lower in refractive index with respect to light than the first metaatom and the second metaatom.

18. The optical element according to claim 13, wherein at least one of the first substrate and the second substrate has a functional film on a surface on an opposite side from the metasurface.

19. An optical element comprising a metasurface,
wherein the metasurface includes a solid medium through which light is capable of propagating,
wherein the solid medium includes, at least, a first metaatom, a second metaatom, and a third metaatom,
wherein the first metaatom, the second metaatom, and the third metaatom differs from one another in refractive index, and
wherein the first metaatom contains one of a silicon oxide or a metal oxide, or is a plastic resin.

20. The optical element according to claim 19, wherein the first metaatom contains at least one type of oxide out of oxides of Si, La, Nb, W, Ti, K, Na, and Li, or is one of a resin containing cycloolefin or a resin containing polyolefin.

21. A method of manufacturing an optical element, comprising:
forming a first metaatom on a surface of a substrate by processing the surface; and
forming a second metaatom different from the first metaatom in refractive index, on the substrate with the first metaatom formed thereon.

22. The method of manufacturing an optical element according to claim 21, wherein the forming the first metaatom includes processing the surface by etching.

23. The method of manufacturing an optical element according to claim 22, wherein the forming the first metaatom includes forming a first mask by photolithography or imprinting, and processing the surface by the etching that uses the first mask.

24. The method of manufacturing an optical element according to claim 21, wherein the forming the second metaatom includes forming the second metaatom by film forming that uses a second mask.

25. The method of manufacturing an optical element according to claim 24, wherein the forming the second metaatom includes forming the second mask by photolithography or imprinting.

26. The method of manufacturing an optical element according to claim 21,
wherein the forming the first metaatom is forming the first metaatom on a first substrate by processing the first substrate, and
wherein the forming the second metaatom is forming the second metaatom on a second substrate by processing the second substrate, the method further comprising:
joining the first substrate and the second substrate so that a metasurface including the first metaatom and the second metaatom is interposed between the first substrate and the second substrate.

27. The method of manufacturing an optical element according to claim 26, wherein the forming the second metaatom includes processing the second substrate by etching.

28. The method of manufacturing an optical element according to claim 27, wherein the forming the second metaatom includes processing the second substrate by the etching with use of a mask formed by photolithography or imprinting.

29. The method of manufacturing an optical element according to claim 26, further comprising forming a third metaatom, after the forming the first metaatom and the forming the second metaatom, before the joining the first substrate and the second substrate, on one of a surface of the first substrate that is on the same side as the first metaatom or a surface of the second substrate that is on the same side as the second metaatom, with use of a film forming method.

30. The method of manufacturing an optical element according to claim 26, wherein the joining the first substrate and the second substrate includes joining the first substrate and the second substrate by surface activated bonding.

31. The method of manufacturing an optical element according to claim 21, further comprising:
forming a third metaatom different from the first metaatom and the second metaatom in refractive index, on the surface with the first metaatom and the second metaatom formed thereon.

32. The method of manufacturing an optical element according to claim 31,
wherein the forming the second metaatom includes forming the second metaatom by film forming, and
wherein the forming the third metaatom includes forming the third metaatom by film forming.

33. The method of manufacturing an optical element according to claim 31, further comprising removing the substrate by polishing the substrate from a surface on an opposite side to the surface of the substrate on which the first metaatom, the second metaatom, and the third metaatom are formed.

34. A product comprising:
a device which emits or receives a target light; and
an optical system which controls the target light,
wherein the optical system includes the optical element according to claim 1.
